(19) United States
(12) Patent Application Publication
(10) Pub. No.: US 2008/0233457 A1
(43) Pub. Date: Sep. 25, 2008

(54) Fuel Supply with Improved Connecting Valve

(75) Inventors: Paul Adams, Monroe, CT (US); Andrew J. Curello, Hamden, CT (US); Constance R. Stepan, Oxford, CT (US); Paul Spahr, New Haven, CT (US)

Correspondence Address: THE H.T. THAN LAW GROUP, WATERFRONT CENTER SUITE 560, 1010 WISCONSIN AVENUE NW, WASHINGTON, DC, 20007, US

(73) Assignee: Societe BIC, Clichy Cedex (FR)

(21) Appl. No.: 11/996,033

(22) PCT Filed: Jul. 14, 2006
(86) PCT No.: PCT/US06/27317

§ 371 Date: Jan. 17, 2008

Related U.S. Application Data
(60) Provisional application No. 60/699,865, filed on Jul. 18, 2005.

(51) Int. Cl. H01M 2/02

(52) U.S. Cl. 429/34

(57) ABSTRACT

Disclosed herein are connecting valves with an interchangeability feature (18, 20) to ensure that the fuel cell fuel matches the fuel cell. Also disclosed are retainer mechanisms (28, 30, 32, 36) capable of releasably connecting the fuel supply to the fuel cell or to the electronic device equipped with a fuel cell. An improvement to the connecting valves to decrease the amount of residual fuel left in the fuel supply is also provided.

### CROSS-REFERENCE TO RELATED APPLICATION

The present application is a continuation-in-part of commonly-owned, co-pending PCT international application serial number PCT/US05/04826, filed on Feb. 16, 2005, the disclosure of which is incorporated herein by reference in its entirety. This international application designates the United States of America among other member states.

### FIELD OF THE INVENTION

This invention relates to a valve for connecting a fuel supply to a fuel cell or to an electronic device equipped with a fuel cell.

### BACKGROUND OF THE INVENTION

Valves that connect a fuel supply or fuel cartridge to a fuel cell or an electronic device equipped with a fuel cell have been disclosed. Suitable connecting valves are disclosed in commonly-owned and/or co-pending U.S. Pat. Appl. Pub. No. US 2005/0022883 A1, entitled “Fuel Cartridge with Connecting Valve”; U.S. Pat. Appl. Pub. No. US 2005/0074643 A1, entitled “Fuel Cartridges for Fuel Cells and Methods for Making Same”; U.S. Pat. Appl. Pub. No. US 2005/0116190 A1, entitled “Fuel Cell Supply Having Fuel Compatible Materials”; and U.S. Pat. Appl. Pub. No. US 2005/0118468 A1, entitled “Fuel Cell Supply Including Information Storage Device And Control System.” Other suitable connecting valves include commonly owned and/or co-pending PCT Pub. No. 2006/050261 A1, entitled “Valves for Fuel Cartridges,” and U.S. Patent Appl. Pub. No. 2006/0071088 A1, entitled “Fuel Cartridge with an Environmentally Sensitive Valve.”

These pending applications and publications are specifically incorporated by reference herein in their entireties.

The present invention is directed to an improved connecting valve.

### SUMMARY OF THE INVENTION

The present invention is directed to connecting valves with an interchangeability feature to ensure that the fuel cell fuel matches the fuel cell.

The present invention is also directed to a retainer mechanism capable of releasably connecting the fuel supply to the fuel cell or the electronic device equipped with a fuel cell.

The present invention is also directed to an improvement to the connecting valve to decrease the amount of residual fuel left in the fuel supply.

### BRIEF DESCRIPTION OF THE DRAWINGS

In the accompanying drawings, which form a part of the specification and are to be read in conjunction therewith and in which like reference numerals are used to indicate like parts in the various views:

FIG. 1 is an exploded view of the two valve components of a connecting valve of the present invention showing an interchangeability feature;

FIG. 2 is a sectional view of the valve components of FIG. 1 with details omitted for clarity;

FIGS. 3A-C are top views of various embodiments of the interchangeability feature of FIG. 1;

FIG. 4 is a top view of another embodiment of the interchangeability feature of FIG. 1;

FIG. 5 is an exploded view of the two valve components of FIG. 1 with a retaining mechanism;

FIG. 6 is a sectional view of the valve components of FIG. 5 in the connected position with details omitted for clarity;

FIGS. 7 and 8 show another embodiment of the retaining mechanism of FIG. 5;

FIGS. 9A-C are cross-sectional views showing other inventive combinations of the retaining mechanism and interchangeability feature; and

FIG. 10 is a sectional, exploded view of the valve components showing a mechanism to maximize the amount of fuel extractable from the fuel supply and a cover for the valve component.

### DETAILED DESCRIPTION OF THE INVENTION

As illustrated in the accompanying drawings and discussed in detail below, the present invention is directed to valves for fuel supplies, which store fuel cell fuels, such as methanol and water, methanol/water mixture, methanol/water mixtures of varying concentrations, pure methanol, and/or methyl clathrates described in U.S. Pat. Nos. 5,364,977 and 6,512,005 B2, which are incorporated by reference herein in their entirety. Methanol and other alcohols are usable in many types of fuel cells, e.g., DMFC, enzyme fuel cells and reformat fuel cells, among others. The fuel supply may contain other types of fuel cell fuels, such as ethanol or alcohols, metal hydrides, such as sodium borohydrides, other chemicals that can be reformatted into hydrogen, or other chemicals that may improve the performance or efficiency of fuel cells. Fuels also include potassium hydroxide (KOH) electrolyte, which is usable with metal fuel cells or alkali fuel cells, and can be stored in fuel supplies. For metal fuel cells, fuel is in the form of fluid-borne zinc particles immersed in a KOH electrolytic reaction solution, and the anodes within the cell cavities are particulate anodes formed of the zinc particles. KOH electrolytic solution is disclosed in U.S. Pat. Appl. Pub. No. US 2003/0077493 A1, entitled “Method of Using Fuel Cell System Configured to Provide Power to One or More Loads,” published on Apr. 24, 2003, which is incorporated by reference herein in its entirety. Fuels can also include a mixture of methanol, hydrogen peroxide and sulfuric acid, which flows past a catalyst formed on silicon chips to create a fuel cell reaction. Moreover, fuels include a blend or mixture of methanol, sodium borohydride, an electrolyte, and other compounds, such as those described in U.S. Pat. Nos. 6,554,877; 6,562,497; and 6,758,871, which are incorporated by reference herein in their entireties. Furthermore, fuels include those compositions that are partially dissolved in a solvent and partially suspended in a solvent, as described in U.S. Pat. No. 6,773,470 and those compositions that include both liquid fuel and solid fuels, described in U.S. Pat. Appl. Pub. No. US 2002/0076602 A1. Fuels also include formic acid. These references are also incorporated by reference in their entireties.

Fuels can also include a metal hydride such as sodium borohydride (NaBH₄) and water, discussed above. Fuels can further include hydrocarbon fuels, which include, but are not limited to, butane, kerosene, alcohol, and natural gas, as set forth in U.S. Pat. Appl. Pub. No. US 2003/0096150 A1, entitled “Liquid Hereto-Interface Fuel Cell Device,” published on May 22, 2003, which is incorporated by reference herein in its entirety. Fuels can also include liquid oxidants that react with fuels. Of course, fuels also include hydrogen, which can be compressed, stored in metal hydrides, or created from a reaction with a hydride, etc.

The present invention is therefore not limited to any type of fuel, electrolytic solution, oxidant solution or liquids or solids contained in the supply or otherwise used by the fuel cell system. The term “fuel” as used herein includes all fuels that can be reacted in fuel cells or in the fuel supply, and includes, but is not limited to, all of the above suitable fuels, electrolytic solutions, oxidant solutions, gaseous, liquids, solids, and/or chemicals and mixtures thereof. The fuel supply of the present invention can also be used to store fuels that are not used in fuel cells. These applications include, but are not limited to, storing hydrocarbons and hydrogen fuels for micro gas-turbine engines built on silicon chips, discussed in “Here Come the Microengines,” published in The Industrial Physicist (December 2001/January 2002), at pp. 20-25. For the purpose of the present application, “fuel cells” also include these micro-engines. Other applications include storing traditional fuels for internal combustion engines, hydrocarbons such as butane for pocket and utility lighters, and liquid propane.

Due to the multiple types of fuel cell fuels, it is desirable that the fuel supplies can be distinguished from each other, so that a fuel supply containing one type of fuel would not be used with a fuel cell requiring a different type of fuel. Such mismatch can be minimized by incorporating interchangeability features to the fuel supplies, the valves and/or the electronic devices. Suitable interchangeability features for fuel supplies have been fully disclosed in commonly owned, co-pending U.S. patent application Ser. No. 10/773,481, entitled “Datum Based Interchangeable Fuel Cell Cartridges,” filed on Feb. 6, 2004, and published as U.S. Pat. Appl. Pub. No. 2005/0173022. This application is incorporated by reference herein in its entirety.

In accordance with one aspect of the present invention, interchangeability for fuel supply valves is accomplished by keys or keying features, which allow a fuel supply to be connected to a fuel cell only when the keys on the valve of the fuel supply match with the keys on the valve connected to the fuel cell or to the device with a fuel cell. The keys can be protrusions on or recesses within the valve body or the keys can be located on an outer surface of the valve, be directly or indirectly connected to the valve, on the fuel supply, or on a movable sealing body within the valves. The keys can also be visual keys. Suitable keys have been disclosed in commonly owned parent International Patent Application No. PCT/US05/04826, entitled “Fuel Supply Systems Having Operational Resistance,” filed on Feb. 16, 2005. This parent international application is incorporated herein by reference in its entirety.

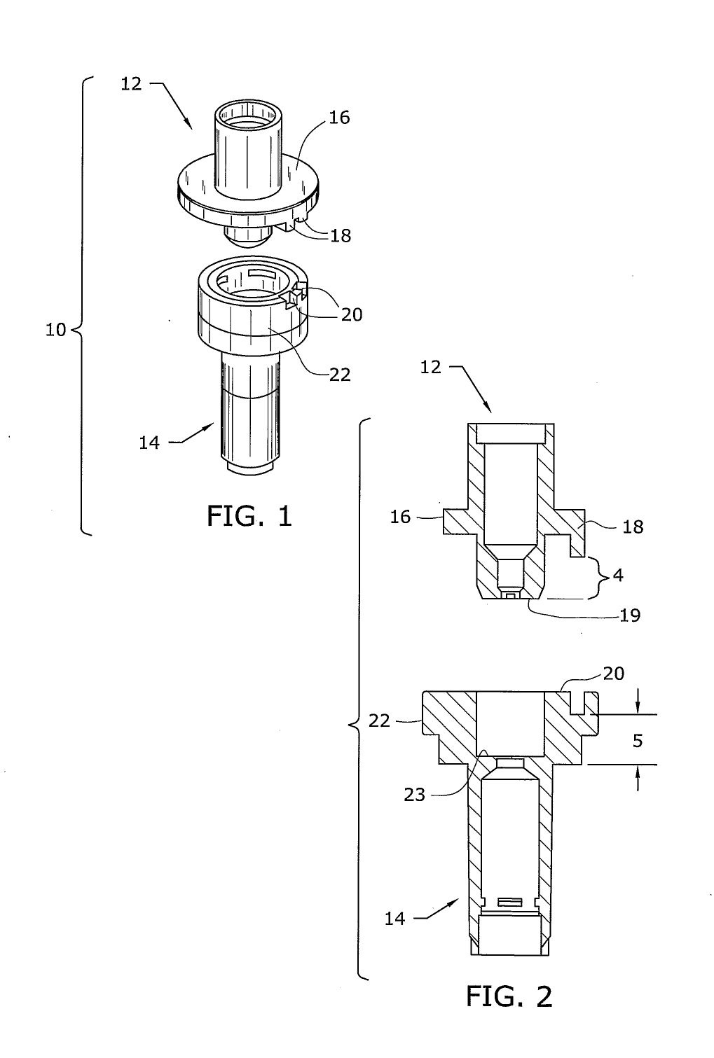

Referring to FIG. 1, a connecting valve 10 is a two-component valve that includes valve components 12 and 14 with an interchangeability feature. Preferably, each valve component comprises an internal seal (such as a check valve, a duckbill valve or a solenoid valve), although internal seals are not always necessary. Two-component valves are fully disclosed in the patent references listed above, and particularly in US 2005/0022883 and WO 2006/050261. Valve component 12 or 14 can be attached to either the fuel supply or the device/fuel cell. As shown, valve component 12 has a rim 16, which has at least one key 18 disposed thereon or dependent therefrom. Preferably, rim 16 has more than one key 18. In this embodiment, key 18 is a rectangular protrusion or tooth, but in other embodiments key 18 can have any shape or size. Valve component 14 has a corresponding key 20, which is a recess, sized and dimensioned to receive key 18. Key 20 can be formed within a body of valve component 14 or within a rim 22, as shown. Protruding key 18 can be located on the other valve component 14, and corresponding recessed key 20 can be located on valve component 12. Rim 16 and rim 22 are shown as circular; however, these rims can have any shape including oval, regular polygons, or irregular polygons.

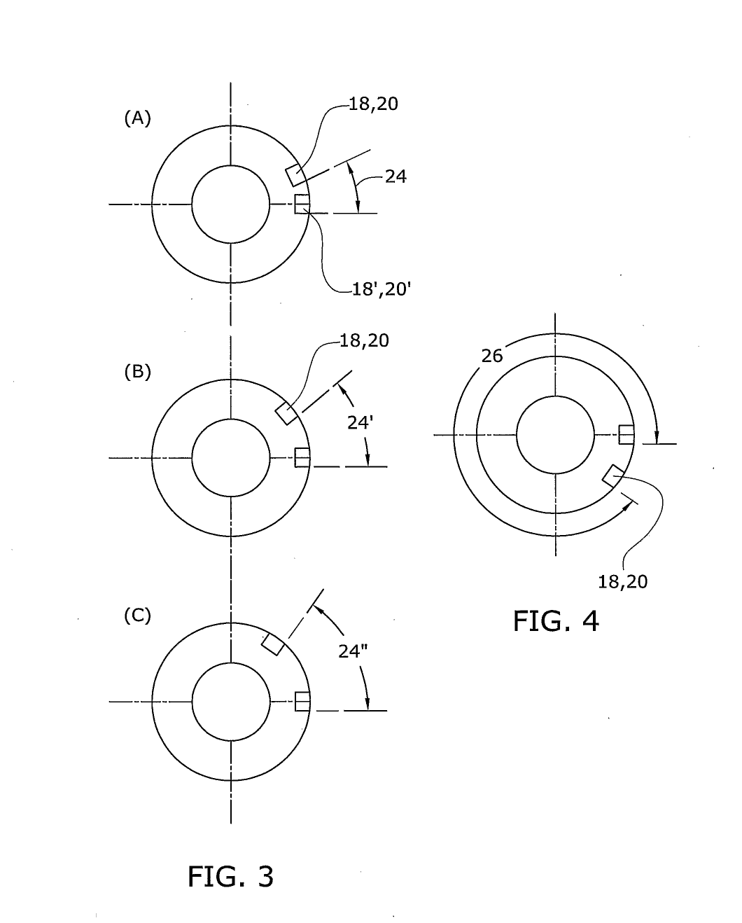

The distance or angle 24, 24′, 24″ between the corresponding reference points on adjacent keys 18 can vary, as shown in FIGS. 3A-3C, to indicate the type of fuel contained in the fuel supply and unless corresponding keys 20 match keys 18, the fuel supply will not be allowed to connect to the fuel cell. In other words, angles 24, 24′, and 24″ are different from each other and each angle represents a different type of fuel or different grade of fuel. Alternatively, angle 24 can be replaced by the complementary obtuse angle 26, as shown in FIG. 4. Keys 18, 20 can have the same or different width, as long as one is receivable by the other one. Angles 24, 26 can be selected to be divisible by a common angle, such as 30° or 45°, or may be divisible by an uncommon angle, e.g., 13° or 27°, to produce unique keys. A distance 4 from a tip of key 18 to an end 19 of valve component 12 should be standardized to match a distance 5 between a bottom of corresponding key 20 and a mating surface 23 of valve component 14 to ensure proper engagement between the two valve components. Proper engagement of fuel supply to fuel cell (or devices equipped with fuel cell) can be accomplished by relation to an arbitrary datum, which is fully disclosed in the '481 application, discussed above.

Interchangeability of the valve components in accordance with the present invention also includes matching multiple types of fuel supplies to a single type of fuel cell. For example, a single direct methanol fuel cell may accept several different types of methanol fuels, such as methanol with or without additives, methanol with varying percentages of concentrations, or methanol with other alcohols added therein. Hence, so long as the valve components are interchangeable, the different types of fuel supplies can be used with a particular fuel cell.

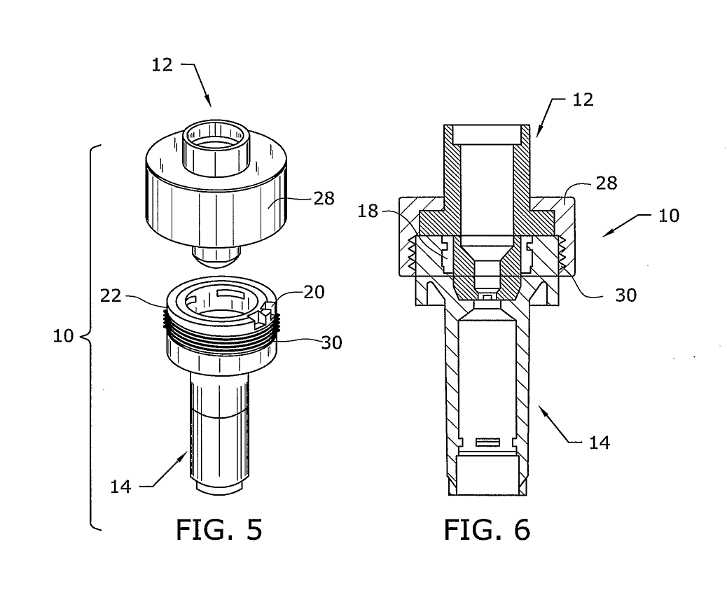

In accordance with another aspect of the present invention, a retaining device is added to valve 10. As illustrated in FIGS. 5 and 6, an internally threaded sleeve 28 is attached to valve component 12 (or to valve component 14), such that sleeve 28 is rotatable relative to the valve component. A portion of the outer surface of corresponding valve component 14, preferably rim 22, is also threaded to engage threaded sleeve 28. The engagement of valve component 12 to valve component 14 can be accomplished by the rotation of sleeve 28 to engage the threads 30. Valve components 12 and 14 can be disengaged by counter-rotation of sleeve 28.

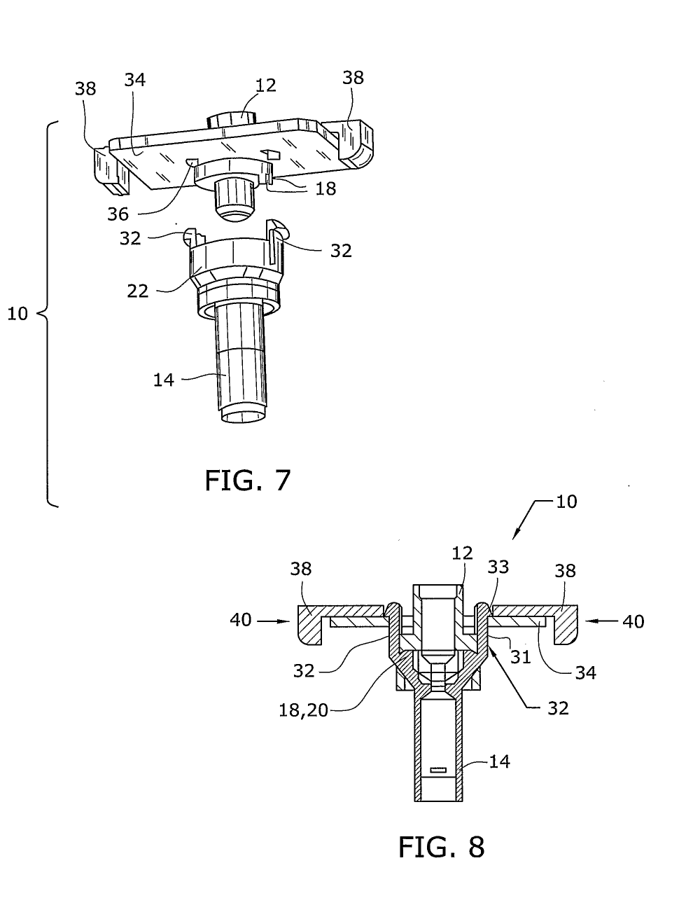

Another embodiment of the retention device is shown in FIGS. 7 and 8. Here, valve component 14 has at least one hook 32 disposed thereon. Preferably, hook 32 is located on rim 22, but can be located elsewhere. Valve component 12 is equipped with a plate 34 having at least one catch, e.g., hole 36, which is sized and dimensioned to receive hook 32. As shown in FIG. 8, after hook 32 passes through catch or hole 36, the enlarged head of hook 32 snaps over the top of plate 34 to secure valve components 12 and 14 to each other. Plate 34 also has release arm(s) 38 disposed thereon. Arms 38 are movable relative to plate 34 and can be pressed against the enlarged head of hook 32, as shown by arrows 40, to release hook 32. After hook 32 is pressed in the direction of arrows 40, valve components 12 and 14 can be disengaged from each other. Hook 32 can be located on either valve component. Additionally, hook(s) 32 and catch(es) 36 can also provide an interchangeability feature similar to keys 18 and 20 since hook(s) 32 have to be aligned with catch(es) 36 before valve components 12 and 14 can engage one another. Hence, unique locations of hook(s) 32 and catch(es) 36 can be dedicated to correspond to unique fuel.

Release arms 38 can be omitted, if this retention feature is a snap fit that is separable by force or requires relative rotational movements between the two valve components to disengage the valve components from each other. Other suitable retention devices are disclosed in commonly owned U.S. provisional patent application Ser. No. 60/699,854, entitled “Separable Fuel Cartridge,” filed on Jul. 18, 2005, and is incorporated by reference herein in its entirety.

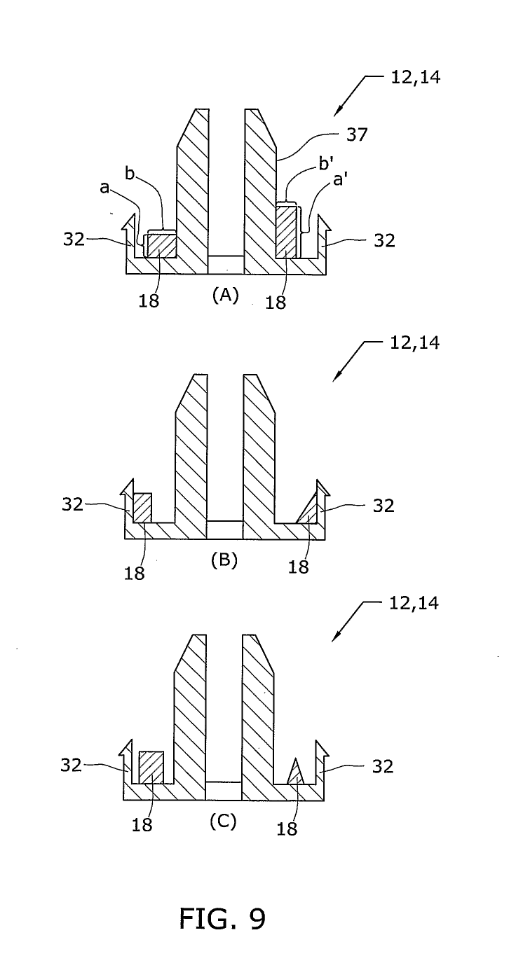

As discussed above, the retaining device(s) can be used alone or with the interchangeability feature. The combination of interchangeability feature and retaining device may have other configurations, such as those shown in FIGS. 9A-C. Here, key 18 can be positioned on the same valve component as hook 32. Key 18 can have any height (a) or (a′) and width (b) or (b′), and can be located adjacent to a body portion of valve component 12, 14. Keys 18 can also be located adjacent to hook 32, or located spaced from the valve body portion and the hooks. Keys 18 can also have any profile, such as quadrilateral, triangular, circular (including half-circle shapes) or any arbitrary shape. Additionally, the enlarged head of hook 32 can be facing outward, as shown, or inward. Hook 32 can also be oriented sideway if the hook can flex to allow straight insertion, or the valve components can be rotated relative to each other to engage each other. Keys 18 can also be positioned angularly around rim 16 at different angles.

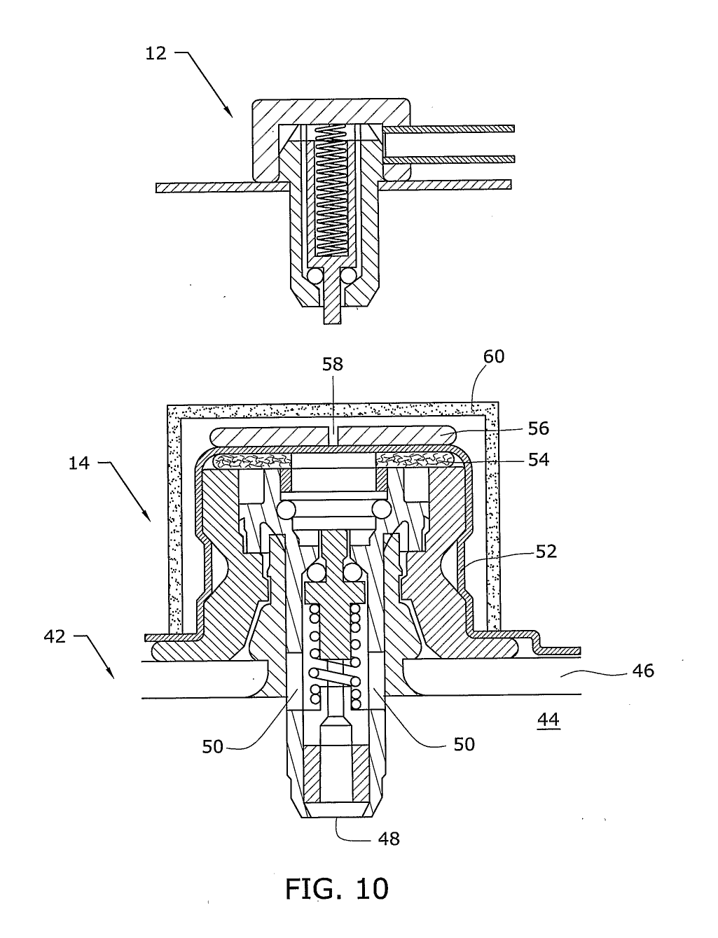

Another improvement to valve 10 of the present invention is shown in FIG. 10. As shown, one of valve components (12, 14) is attached to a fuel supply 42, which contains a fuel 44, and the other valve component is connected to a fuel cell or a device equipped with a fuel cell. When the length of a valve component penetrates relatively deep into the fuel supply, more residual fuel can be trapped in the fuel supply not being used. More specifically, in conventional fuel supplies the residual fuel located between a top wall 46 of fuel supply 42 and a distal end 48 of valve component 12, 14 may become trapped. However, to maximize the amount of fuel retrievable from fuel supply 42, aperture(s) 50 is cut out from a body of the valve component, and preferably aperture 50 is in fluid communication with residual fuel 44 and is positioned as flush with top wall 46 as possible. In another embodiment, aperture 50 can also be a U-shaped cut-out running toward distal end 48.

Another improvement of the present invention is an optional cover 52 that can be placed on one or both valve components 12 and 14, as shown in FIG. 10, to provide support for the valve component. Cover 52 preferably includes an aperture and an absorbent material 54 disposed at an outer tip of valve component 12, 14 as shown. When valve components 12 and 14 are engaging each other or are being disengaged from each other, residual fuel within or between the valve components may be absorbed by absorbent material 54. Absorbent material 54 can be any material that can absorb fuel, including sponges, foams or fillers. Suitable fillers include polymeric fibers, such as polyester, polyethylene, polyolefin, polyacetal, or polypropylene fibers, or plant-based fibers, such as hemp, cotton, or cellulose acetate.

Additionally, an optional elastomeric disk 56 can be placed above absorbent material 54. Disk 56 can be placed outside cover 52, as shown, or inside cover 52. Preferably, elastomeric disk 56 has an aperture or slit 58, which is adapted to allow the other valve component, e.g., the top valve component in FIG. 10, to pass through. Aperture 58 acts as a wiper to keep residual fuel within cover 52 as the top valve component is being withdrawn. Preferably, aperture 58 forms a seal with the inserting or withdrawing valve component. Optionally, aperture 58 is a closed slit to form another seal outside of cover 52.

Additionally, a cap 60 can be placed on top of one or both valve components 12 and 14. Cap 60 can protect the valve component or fuel supply if the cap is used with the fuel supply during shipping and handling. Cap 60 can be removed prior to use and can be replaced to protect the valve component when no longer in use. Cap 60 can be made from an elastomeric material, a plastic, etc., and can be placed or stretched over the cover 52. If cap 60 is made of an elastomeric material, then it may have an aperture similar to aperture 58 described above and functions similar to aperture 58 and does not need to be removed. Cap 60 can also be made of a rigid material, such as plastic or metal. Additionally, multiple motions may be required to remove cap 60 from the valve component, e.g., cap 60 may be attached to the valve component via a bayonet mount or through an L-shaped channel and corresponding protrusion sliding in the channel. Such caps, including multiple-motion caps, are disclosed in International Patent Application No. PCT/US 05/04826, discussed above.

Valve components 12 and 14 are illustrated in FIG. 10 with relevant internal mechanism, and as shown each comprises a check valve. For clarity these internal mechanism are omitted from the valve components in the other Figures. However, it is understood that valve components 12 and 14 may include a check valve therein. Additionally, the interchangeability device and the retaining mechanism shown in FIGS. 1-9 can be used with the valve components of FIG. 10.

As used herein, the term “fuel supply” includes, but is not limited to, disposable cartridges, refillable/reusable cartridges, containers, cartridges that reside inside the electronic device, removable cartridges, cartridges that are outside of the electronic device, fuel tanks, fuel refilling tanks, other containers that store fuel and the tubes connected to the fuel tanks and containers. While a cartridge is described below in conjunction with the exemplary embodiments of the present invention, it is noted that these embodiments are also applicable to other fuel supplies and the present invention is not limited to any particular type of fuel supply.

While it is apparent that the illustrative embodiments of the invention disclosed herein fulfill the objectives stated above, it is appreciated that numerous modifications and other embodiments may be devised by those skilled in the art. Therefore, it will be understood that the appended claims are intended to cover all such modifications and embodiments, which would come within the spirit and scope of the present invention.

We claim:

1. A fuel supply containing fuel cell fuel adapted to be connected to a host device equipped with a fuel cell or to a fuel cell, wherein the fuel supply comprising:
a first valve component adapted to connect to a second valve component on the fuel cell or host device to establish a fuel flow path from the fuel supply to the fuel cell, and wherein the first and second valve components comprise an interchangeability element to ensure that the fuel cell fuel or fuel supply is compatible with the fuel cell, wherein said interchangeability element comprises at least one key and at least one corresponding matching key, and said key and said matching key are disposed on the housing of the valve components.

2. The fuel supply of claim 1 wherein the first and second valve components further comprise a retention mechanism to retain the valve components together after a fuel flow path is formed.

3. The fuel supply of claim 2, wherein the retaining mechanism comprises a threaded rotatable sleeve disposed on one valve component, said threaded rotatable sleeve is adapted to thread said one valve component to the other valve component to releasably retain the two valve components to each other.

4. The fuel supply of claim 2, wherein the retaining mechanism comprises at least a hook disposed on one valve component and at least a catch disposed on the other valve component, said hook and catch are adapted to engage each other to releasably retain the two valve components to each other.

5. The fuel supply of claim 4, wherein the retaining mechanism further comprises a release member to disengage said hook from said catch.

6. The fuel supply of claim 4, wherein the key and the hook are disposed on the first valve component.

7. The fuel supply of claim 6, wherein said key is disposed adjacent to said hook.

8. The fuel supply of claim 6, wherein said key is spaced from said hook.

9. The fuel supply of claim 6, wherein said key is disposed adjacent to the body of the first valve component.

10. The fuel supply of claim 6, wherein said key has a rectangular, circular or triangular profile.

11. The fuel supply of claim 1, wherein said key comprises a plurality of protrusions angularly disposed on the body of one valve component and the matching key comprises a plurality of matching recesses angularly disposed on the body of the other valve component.

12. A fuel supply containing fuel cell fuel adapted to be connected to a host device equipped with a fuel cell or to a fuel cell, wherein the fuel supply comprising:
a first valve component adapted to connect to a second valve component on the fuel cell or the host device to establish a flow of fuel from the fuel supply to the fuel cell, and wherein at least one of the valve components comprises a cover containing an absorbent material.

13. The fuel supply of claim 12, wherein said at least one valve component further comprises a wiper to maintain residual fuel within said cover during disconnection.

14. The fuel supply of claim 13, wherein said wiper is disposed on an elastomeric member located proximate to the absorbent material.

15. The fuel supply of claim 12, wherein said at least one valve component is covered by a removable cap.

16. The fuel supply of claim 12, wherein the first valve component comprises a valve body, said valve body defines at least an opening to increase the amount of fuel transportable from the fuel supply to the fuel cell.

17. A fuel supply containing fuel cell fuel adapted to be connected to a host device equipped with a fuel cell comprising:
a first valve component adapted to connect to a second valve component on the fuel cell or the host device to establish a fuel flow path there between;
a means for ensuring interchangeability between the two valve components; and
a means for retaining the two valve components together.
